(19) United States
(12) Patent Application Publication
(10) Pub. No.: US 2005/0142059 A1
(43) Pub. Date: Jun. 30, 2005

(54) Method for continuous preparation of nanometer-sized hydrous zirconia sol using microwave

(76) Inventors: Hee Young Kim, Yuseong-ku (KR); Yong Ki Park, Yuseong-ku (KR); Kyung Koo Yoon, Yuseong-ku (KR); Hyung Sup Lim, Ansan (KR)

Correspondence Address: NIELDS & LEMACK, 176 EAST MAIN STREET, SUITE 7, WESTBORO, MA, 01581, US

(21) Appl. No.: 10/510,265

(22) PCT Filed: Jun. 26, 2003
(86) PCT No.: PCT/KR03/01252

(30) Foreign Application Priority Data
May 3, 2003 (KR) 10200313620

(51) Int. Cl. C01G 25/02

(52) U.S. Cl. 423/608

(57) ABSTRACT

The present invention relates to a method for continuous preparation of a hydrous zirconia sol dispersed by nanometer-sized spherical hydrous zirconia particles having an average diameter(dₚ) of 1˜250 nm, which method comprises supplying the aqueous solution of a zirconium salt at a concentration of 0.001-0.2 mole/l to a reactor consisting of one or more than two reaction tubes, and then irradiating microwave to the stream of the said aqueous solution in the reactor so that the said solution may be heated in a flow state. Contrary to the method employing a conventional batch-type reactor or semi-continuous stirred-type reactor, the method for continuous preparation of a hydrous zirconia sol according to the present invention can allow various operational parameters to be controlled in a certain range and thus contributes to remarkably improve the quality of a hydrous zirconia sol to be prepared or of the zirconia powder obtainable as a final product.

### TECHNICAL FIELD

The present invention relates to a method for preparation of a nanometer-sized hydrous zirconia sol, particularly a method for continuous preparation of a nanometer-sized spherical hydrous zirconia (ZrO₂.nH₂O) sol required for preparing fine particles of a pure zirconia (ZrO₂) or a zirconia-based composite metal oxides, which are used as basic material for functional ceramics such as abrasives, abrasion-resistant materials, solid-state electrolytes in fuel cell, sensor, coatings and the like; and structural ceramics such as mechanical parts, optical connectors, artificial teeth and the like.

The present invention relates, more particularly, to a method for continuous preparation of spherical hydrous zirconia in the form of sol having an average particle size (diameter) of about 1˜250 nm and a small particle size distribution.

A hydrous zirconia sol is a solution wherein hydrous zirconia particles having a diameter of about 1˜250 nm are dispersed in a colloidal state. And the hydrous zirconia may be prepared by precipitation of a zirconium salt used as precursor (starting material) in an aqueous solution.

The hydrous zirconia sol may be pH-controlled, washed, separated or concentrated to be applied as various materials such as (i) electronic materials or coating materials in the form of stabilized sol itself, (ii) functional ceramics or electronic materials in the form of monodispersed, nanometer-sized powder subjected to drying and/or calcination, (iii) materials for catalysts or batteries/cells subjected to surface-modification by coating, (iv) functional ceramics or structural ceramics in the form of composite materials combined with other components, and the like.

To provide a method for effectively preparing the said multi-purpose hydrous zirconia sol is important for processing effectiveness, preparation cost and quality of the final product.

Recently, there are required monodispersed spherical particles of the hydrous zirconia having a sphere-like shape, a nanometer-sized average particle diameter and a small particle size distribution in consideration of the usage and quality of zirconia ceramics.

### BACKGROUND ART

There have been various conventional methods for preparing hydrous zirconia sol, for example, pH-controlled co-precipitation, forced hydrolysis, alkoxide-based sol-gel process and hydrothermal method.

The pH-controlled co-precipitation is provided for preparing the particles of zirconia-based composite metal oxides. However, this method has many problems in that the co-precipitates having a uniform composition in each particle can be hardly obtained, that the co-precipitates prepared after neutralization can be hardly filtered and separated since they are susceptible to gellation, and that the anion impurities can be hardly removed with water.

Moreover, the pH-controlled co-precipitation has problems that the separated particles can hardly be crushed in a desired size since they are agglomerated into a hard lump during calcination, and thus increasing the possibility for the contamination of impurities therein during pulverization of the lump, thereby deteriorating the quality of the particles.

In the widely applied forced hydrolysis, a reaction time should be long enough to increase a reaction yield. Moreover, since the metallic compounds to be introduced as a stabilizer cannot be completely precipitated and its components are eluted out in the course of separation and washing of the precipitates, the composition required in the zirconia particles product cannot be suitably controlled.

Further, in the conventional hydrolysis method, the hydrous zirconia particles prepared in the course of the reaction agglomerate easily with each other, and the degree of agglomeration becomes more severe during separation and drying after the reaction. There is known an azeotropic dehydration method employing organic solvents having a boiling point equal to that of water to prevent the said agglomeration among the particles. But, this method cannot completely solve the problem.

According to the recent report as disclosed in “Y. T. Moon et al, J. Am. Ceram. Soc., 78(4), 1103-1106 and 78(10), 2690-2694 (1995)”, a precipitation method may be effectively employed for the preparation of hydrous zirconia sol. In the precipitation method, organic solvents such as alcohols to be used in addition to water can lower the precipitation temperature while lowering the solubility of the zirconium salts used as starting materials, since they have low dielectric constant.

The said article is based on a precipitation method using a water-alcohol mixture as solvent, and discloses that narrowly distributed spherical hydrous zirconia sol having an average diameter of 0.28 μm can be obtained in a batchwise manner by rapidly heating within a microwave oven the reaction mixture in a beaker without stirring.

The present inventors repeated the same procedure as the said article. Their experimental results revealed that the agglomeration severely occurred among the hydrous zirconia particles that are generated belatedly after an initial precipitation occurs according to the rapid rise of temperature, although the same zirconium salt solution was heated rapidly within a microwave oven in a disturbance-free, static state without flow or stirring, and that the particle size distribution was large thereby.

The present inventors discovered that the quality of the hydrous zirconia particles obtained was more deteriorated at a larger volume of the solution tested, and that local temperatures within the disturbance-free aqueous solution were not uniformly raised despite of the microwave heating. Although a uniform heating by microwave may be achievable when the volume of the aqueous solution is very small, the effectiveness of uniform heating by microwave was gradually reduced as its volume was increased.

Yet, there has not been known a method for continuous preparation of a sol of spherical hydrous zirconia particles with an average diameter less than about 250 nm and a small particle size distribution based on the precipitation method using a water-alcohol mixture as solvent.

Alternatively, zirconium alkoxides such as zirconium butoxide (Zr[O(CH₂)₃CH₃]₄) may be used as a starting material instead of a zirconium salt. However, this alkoxide-based sol-gel process is not adequate for a commercial bulk preparation because of its too expensive cost.

A hydrous zirconia sol can also be prepared in a hydrothermal method. U.S. Pat. No. 5,275,759 (1994) to S. Osaka et al. discloses that a hydrous zirconia sol can be prepared from an aqueous solution containing zirconium salts and urea in the hydrothermal method at a temperature of 60˜300° C. and under pressure. However, the hydrothermal method for preparing a hydrous zirconia sol has a problem in economical feasibility, since it requires an expensive hydrothermal apparatus and very long reaction time. Further, serious particle agglomeration is observed after calcination of the particles of the hydrous zirconia sol obtained by the hydrothermal method, since the size of hydrous zirconia particles is too small and their size distribution is broad.

These conventional methods for preparing a hydrous zirconia sol cannot provide a means for bulk preparation of hydrous zirconia sol required for preparation of spherical zirconia particles having an average diameter less than about 250 nm and a small particle size distribution. Meanwhile, the shape of hydrous zirconia particles in a state of sol has a close relation with size, shape and size distribution of finally obtained pure zirconia particles or zirconia particles compounded with other metal oxides; and with the degree of agglomeration among the particles. Therefore, it is required to develop a method for continuous preparation of hydrous zirconia sol to commercially prepare pure zirconia particles or zirconia particles compounded with other metal oxides. In this method, a sol of hydrous zirconia particles with a nanometer-sized average diameter, a narrow size distribution and a low degree of agglomeration among the particles should be prepared.

### DISCLOSURE OF THE INVENTION

An object of the present invention is to provide a method for preparation of a nanometer-sized spherical hydrous zirconia sol having an average diameter of about 1 to 250 nm and a small particle size distribution.

Another object of the present invention is to provide a method for continuous preparation of an excellent hydrous zirconia sol which can be applied as various materials such as (i) electronic materials or coating materials in the form of stabilized sol itself, (ii) functional ceramics or electronic materials in the form of monodispersed, nanometer-sized powder subjected to drying and/or calcination, (iii) materials for catalysts or batteries/cells subjected to surface-modification by coating, (iv) functional ceramics or structural ceramics in the form of composite materials combined with other components, and the like.

As a result of the present inventors' extensive studies, they have now found that a spherical hydrous zirconia sol having a nanometer-sized average diameter and a small particle size distribution can be obtained by heating the aqueous solution of a zirconium salt, which is maintained in a state of continuous flow in a tubular reactor, with microwave as an energy source. The present invention is attained on the basis of these findings.

According to the present invention, when the aqueous solution of a zirconium salt is heated with microwave in a state of continuous flow, particle size distribution is controlled to be small and the agglomeration of the particles obtained thereby is unnoticeable. The result is rather surprising one from the well known point of view that there always exists a velocity gradient in a radial direction within a tubular reactor due to the shear stress imposed by the solid inner wall of the reactor upon the flow.

The present invention provides a method for continuous preparation of a well dispersed spherical hydrous zirconia particles with an average diameter(dₚ) of 1˜250 nm in the form of sol solution, which method comprises supplying the aqueous solution of a zirconium salt at a concentration of 0.001˜0.2 mole/l to a reactor consisting of one or more than two reaction tubes, and then irradiating microwave to the stream of the said solution in the reactor(s) so that the said solution may be internally heated in a flow state.

Hydrolysis of the aqueous solution of a zirconium salt and precipitation of the particles are completed therein when the said solution is heated to a temperature of about 70˜100° C.

According to the present invention, the aqueous solution of a zirconium salt in the reactor(s) may be heated to about 70˜100° C. by another heating means in addition to the said microwave.

An average diameter(dₚ) of the hydrous zirconia particles prepared according to the present invention may be in the range of 1˜250 nm.

The cross-section of a reaction tube used in the present invention may have a circular or concentric annular form. If the diameter of the circle or the equivalent diameter of the annular area is represented as D, the value D is preferred to be selected within about 0.01˜3 cm.

According to the present invention, a dispersant may be added to the said aqueous solution of a zirconium salt at the concentration of 0.05˜20 g/l.

According to the present invention, the average flow velocity (u) of the said aqueous solution of a zirconium salt is preferably regulated at an average residence time-of the solution in the said reactor so as to be within about 1˜60 seconds.

According to the present invention, a starting material, that is, a zirconium salt to be used as zirconia precursor is not limited, as long as it is water soluble. The zirconium salts include, for example, zirconium oxychloride or zirconyl chloride (ZrOCl₂), zirconium tetrachloride (ZrCl₄), zirconyl nitrate (ZrO(NO₃)₂), zirconium sulfate (Zr(SO₄)₂) and the like. Zirconium oxychloride is most widely used.

When zirconium oxychloride is used as the zirconium salt, hydrolysis to proceed in an aqueous solution can be represented as the following reaction formula:
ZrOCl₂+(n+1)H₂O→ZrO₂.nH₂O+2H⁺+2Cl⁻

As illustrated in the above formula, 1 mole of ZrOCl₂ is changed to hydrous zirconia (ZrO₂.nH₂O) with 2 moles of “H⁺” and “Cl⁻” ions being prepared respectively.

Water is generally used as a solvent for the precipitation, since the zirconium salt is very soluble in water at low temperature. When only water is used as the solvent, the precipitation temperature and dielectric constant are high. Then, alcohol can be preferably used with water to lower the precipitation temperature and dielectric constant. Alcohols to be used with water include, for example, ethyl alcohol, propyl alcohol (1-propyl alcohol or 2-propyl alcohol), butyl alcohol and the like.

The composition ratio of water-alcohol mixture used for the aqueous solution of a zirconium salt may be decided in consideration of the average diameter of desired hydrous zirconia particles, concentration of zirconium salt, washing and concentration of sol to be prepared, separation and purification of solvent, regeneration cost and the like.

The mole ratio of the alcohol/water solvent to be used in the present invention is preferably in the range of about 0.5˜5.0. Confining the particles having an average diameter less than 100 nm according to the general definition of “nanoparticles”, the mole ratio of alcohol/water not less than about 0.7 is preferred for preparation of a sol of hydrous zirconia nanoparticles without significantly lowering the concentration of the zirconium salt.

The stabilizers such as halide (chloride and bromide, etc.), carbonate and nitrate of Y, Ce, Ca or Mg may be further added to the aqueous solution of a zirconium salt depending on usage of the hydrous zirconia to be prepared. Generally, the stabilizers are added so that the amount of the finally prepared oxides such as Y₂O₃, CeO₂, CaO and MgO may be up to 30 mole % on the basis of ZrO₂.

According to the present invention, continuous preparation of a hydrous zirconia sol from the aqueous solution of a zirconium salt can be carried out by irradiating microwave to the aqueous solution of a zirconium salt flowing in a tubular reactor consisting of one or more than two reaction tubes so that the solution can be heated in a flow state.

### BRIEF DESCRIPTION OF THE DRAWINGS

The above objects, other features and advantages of the present invention will become more apparent by describing the preferred embodiment thereof with reference to the accompanying drawings, in which:

FIG. 1 is a schematic drawing illustrating a process for continuously preparing a hydrous zirconia sol according to the present invention; FIG. 12a being a schematic drawing illustrating a microwave-applied heating means; FIG. 1b being a schematic drawing illustrating a heat exchanger type heating means employing another heating source in combination with a microwave-applied heating means; and FIG. 1c being a schematic drawing illustrating a stirred reactor type heating means application of employing another heating medium in combination with a microwave-applied heating means;

FIG. 2 is a schematic drawing illustrating a basic construction of a tubular reactor and a heating method to be used in the present invention; FIG. 2a being a schematic drawing illustrating a tubular reactor consisting of a reaction tube with circular cross-section and its heating method; and FIG. 2b being a schematic drawing illustrating a tubular reactor consisting of a reaction tube with annular concentric cross-section and its heating method;

FIG. 3 is a drawing illustrating a heat exchanger type reaction zone employing another heating medium and connected to a microwave-heated reaction zone according to the present invention; FIG. 3a being a drawing illustrating a heat exchanger type reaction zone consisting of multiple coil-type reaction tubes; and FIG. 3b being a drawing illustrating a heat exchanger type reaction zone consisting of multiple straight reaction tubes;

FIG. 4 is a drawing illustrating a method for hybridly heating the reactant in the reaction tube by supplying microwave together with another heating medium according to the present invention; FIG. 4a illustrating a method for heating the reactant in a heat exchanger type reactor having a coil-type reaction tube; and FIG. 4b illustrating a method for heating the reactant in a heat exchanger type reactor having multiple straight reaction tubes;

FIG. 5 is a schematic drawing illustrating a method for heating the reactant by separately supplying microwave and another heating medium in a multi-partitioned reactor according to the present invention; FIG. 5a illustrating a method for heating the reactant in a single reactor having a reaction zone (1a) subjected to microwave heating and a reaction zone (1b) subjected to heating by another heating medium; and FIG. 5b illustrating a method for heating the reactant in a reactor consisting of multiple reaction tubes which are multi-partitioned in accordance with the number of heating medium; and

FIG. 6 is a microscopic photograph for a hydrous zirconia sol prepared according to the method of the present invention.

### DETAILED DESCRIPTION OF THE INVENTION

The preferred embodiments of the present invention will be described in detail with reference to the annexed drawings.

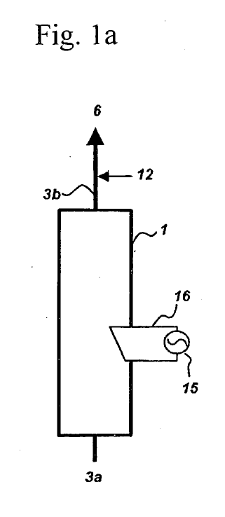

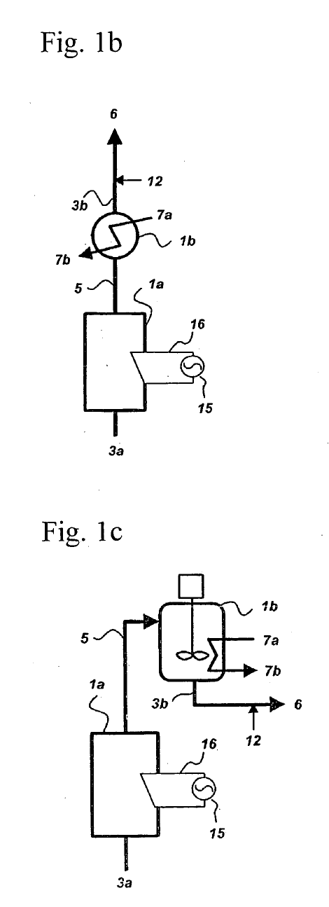

FIG. 1 shows a schematic drawing illustrating a process for continuously preparing a hydrous zirconia sol according to the present invention.

The first process for preparing a hydrous zirconia sol(6), as illustrated in FIG. 1a, is performed by heating the aqueous solution of a zirconium salt(3a) flowing in the reaction tube constituting a tubular reactor(1) with microwave, generated in a microwave generator(15) and then introduced through the supplying section(16), to the temperature at which the hydrolysis reaction as well as the precipitation of the particles are substantially accomplished.

The second process for preparing a hydrous zirconia sol(6), as illustrated in FIG. 1b, is performed by firstly heating the aqueous solution of a zirconium salt(3a) flowing in the reaction tube constituting a tubular reactor(1a) with microwave, and then secondly heating the resultant heated reaction mixture(5) with a separate heating medium(7) passing through the second reaction zone(1b) to the temperature at which the hydrolysis reaction as well as the precipitation of the particles are substantially accomplished. The order of the first reaction zone and the second reaction zone may be changed in this process with the results of the present invention being not substantially affected thereby.

The third process for preparing a hydrous zirconia sol(6), as illustrated in FIG. 1c, is performed by firstly heating the aqueous solution of a zirconium salt (3a) flowing in the reaction tube constituting a tubular reactor(1a) with microwave, and then secondly heating the resultant heated reaction mixture(5) with a separate heating medium(7) passing through the second reaction zone(1b) equipped with a stirrer to the temperature at which the hydrolysis reaction as well as the precipitation of the particles are substantially accomplished. The order of the first reaction zone and the second reaction zone may be changed in this process with the results of the present invention being not substantially affected thereby.

The microwave to be used in the present invention is an electromagnetic wave having a frequency in the range of 300 MHz˜30 GHz. Frequencies of 896±3 MHz, 915±5 MHz, 2,450±9 MHz and the like are usually used for the purpose of commercial-scale heating. However, the present invention is not affected by a certain frequency.

Microwave can be generated by various means, and magnetron is most widely used for the purpose of heating. Although it departs from the scope of the present invention, Microwave may be used in continuous wave mode or pulse mode. However, either mode of microwave may be supplied to the reactor for practicing the present invention.

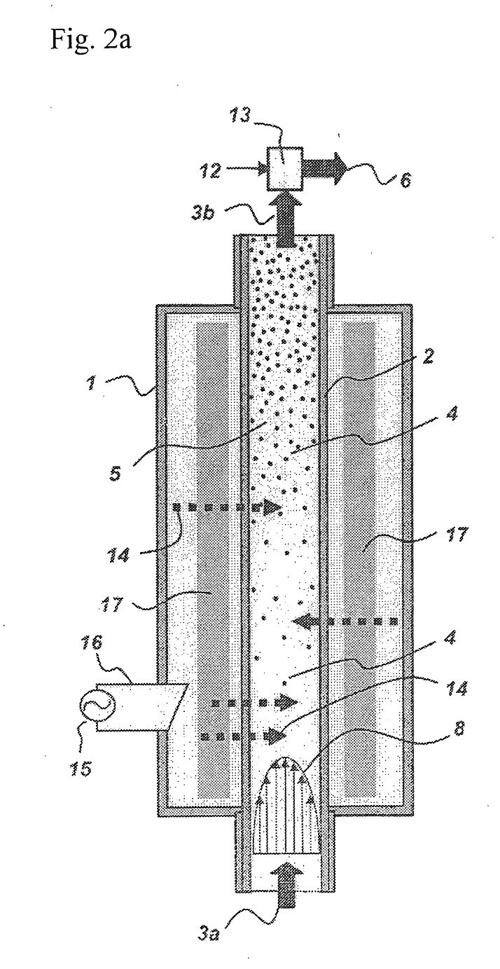

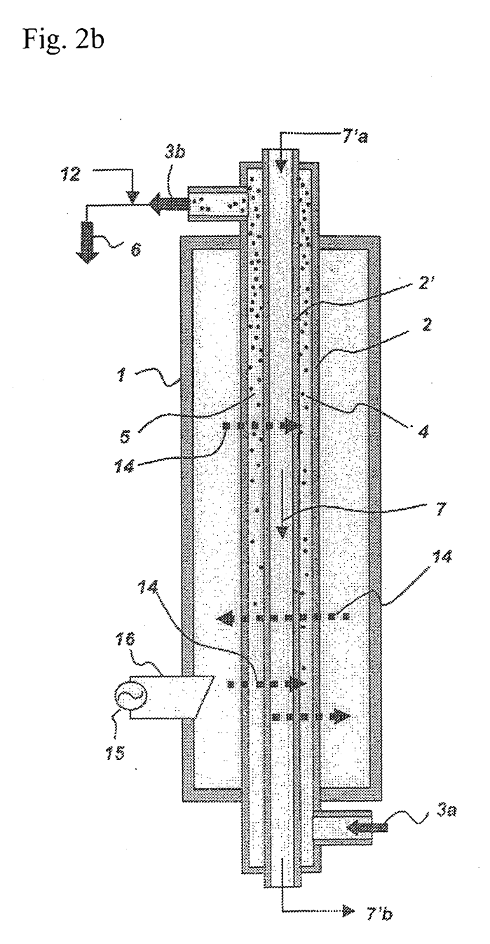

There is more specifically disclosed a method for continuous preparation of a hydrous zirconia sol in a tubular reactor having one reaction tube as illustrated in FIG. 2a. The reaction tube(2) in which the aqueous solution of a zirconium salt(3) flows, passes through the reactor(1). The heat needed for hydrolyzing and precipitating the aqueous solution of a zirconium salt is provided by microwave(14) supplied into the reactor(1). The said microwave(14) is generated in a microwave generator(15), is supplied through the microwave supplying section(16) connected with the metallic shell of the reactor(1). The microwave supplied thereby passes through the wall of the reaction tube(2) and is absorbed and than transformed to heat in the aqueous solution of a zirconium salt maintaining a flow state.

The materials of reaction tube(2) allowing microwave to pass through easily include silica(SiO₂)-based glasses such as quartz or pyrex, ceramic materials such as alumina(Al₂O₃) and silicon nitride(Si₃N₄), and the like.

Although the cross sectional shape of a reaction tube(2) is not limited, a circular or annular concentric shape is preferable. The cross sectional area of the tube may be uniform along the flow direction of the reactant. However, the cross sectional area may be increased from the inlet toward the outlet along the length direction without causing any problems.

According to the present invention, a microwave generator(15) and a microwave supplying section(16) may be constituted diversely. For example, according to the capacity required, one or more than two magnetrons supplied with electricity may be connected directly to the shell of the reactor(1) in an integrated form of both the generator(15) and the supplying section(16) Further, microwave may be introduced into the reactor(1) from a separately installed microwave generator(15) through the supplying section(16) consisting of waveguide components, tuner, isolator and the like that are connected between the generator(15) and the reactor(1). Further more, a fraction of the waveguide components constituting the microwave supplying section may itself be modified to be the metallic shell of a reactor(1) through which one or multiple number of reaction tube(2) passes.

The reaction intermediate(5) comprising both the aqueous solution of a zirconium salt(3a) and a reactant output has a property of absorbing microwave and generating heat. Thus, the reaction intermediate(5) easily absorbs the microwave(14) passing through the wall of the reaction tube(2) and then is easily heated.

Although the mechanism to prepare a hydrous zirconia sol(6) from the aqueous solution of a zirconium salt(3a) as a raw material of a hydrous zirconia has not been well known, the generation of a hydrous zirconia sol is considered to be related with the hydrolysis of a zirconium salt and the precipitation of hydrous zirconia particles. As illustrated in the said formula of hydrolysis, the hydrolysis may also be considered to initiate at least partially in the course of provision of the said zirconium aqueous solution.

When the temperature(T) of the continuously supplied aqueous solution of a zirconium salt(3a) is increased by microwave heating to above the precipitation temperature(Tₚ) at a certain distance(z=zₚ) from the inlet of the reaction tube, the zirconium salt in a supersaturated state begins to precipitate since the solubility of the zirconium salt becomes lowered with the increase of temperature. Here, “z” is the distance from the inlet at the reaction tube, and the temperature T(z) at a distance z increases with z from the inlet temperature(Tᵢ) at zᵢ=0. The nuclei of the precipitate, in other words, the major component of the precipitated particles may be the zirconium salt itself or the hydrous zirconia generated by the hydrolysis. When the S reaction mixture is heated to above Tₚ, spherical particles(4) grow in size with the agglomeration of the nuclei particles or with the continuous precipitation of the nuclei on the surfaces of the growing particles(4).

Since the growth of the particles proceeds instantly in a complicated manner, changes in their composition or the rapid transformation within the reaction intermediate(5) can hardly be understood in a physical or a chemical point of view.

When the solution (3a) as a starting material is heated to the boiling point (T_{b}) or the outlet temperature(Tₒ) below the boiling point as it flows toward the outlet(z=zₒ) through the reaction tube(2), the generation and growth of the precipitated particles(4) are completed and discharged in a suspension(3b) through the outlet of the reaction tube. The suspension(3b) of particles, in a state of sol, is mixed with a pH control agent(12) in a mixer(13) unless otherwise provided, and then is discharged as a reaction product(6) in a state of sol having an adequate pH range in about 5˜12. The term “sol” herein means a suspension in which the precipitated particles(4) prepared thereby are dispersed in a solution without being subject to gelation due to particle agglomeration.

In order to prepare the spherical hydrous zirconia particles with an average diameter of less than 250 nm and a small particle size distribution according to the present invention, it is preferable for the aqueous solution(3a) of a zirconium salt to flow in a laminar state, that is, a state without any noticeable turbulence within the reaction tube (2). Especially, it is important that the laminar flow having a velocity gradient(8) formed by the pressure difference between the inlet and the outlet of the reaction tube and by the shear stress due to a resistance of the inner wall of the reaction tube should be maintained at least until the temperature reaches around the precipitation temperature(Tₚ) initiating the formation of nuclei of the precipitated particles(4).

The term “precipitation” herein means a phenomenon that the nuclei of zirconium salts or hydrous zirconia begin to form, even though they cannot be visually confirmed. The precipitation temperature(Tₚ) and the corresponding distance(zₚ) for initiating precipitation cannot be precisely determined. They surely are, however, present between the inlet temperature(Tᵢ) that the aqueous solution of a zirconium salt is supplied and the outlet temperature of the reaction product(Tᵢ<Tₚ<Tₒ).

Since the aqueous solution of a zirconium salt may initiate a precipitation and gelation of particles followed by sedimentation even at around the room temperature, the preferable inlet temperature (Tᵢ) of the aqueous solution of a zirconium salt is not more than 25° C.

It is necessary to set the outlet temperature(Tₒ) of the reaction product so as to fully generate and grow the precipitated particles in the suspension(3b) According to the present inventors' examination, it was confirmed that there was no problem in preparation of the precipitated hydrous zirconia particles, though the reaction mixture was heated to the boiling point(T_{b}) of the aqueous solution of a zirconium salt or the temperature range of about 70° C<Tₒ<T_{b}.

When the reaction mixture is heated to its boiling point(T_{b}), many bubbles are formed in the reaction mixture. However, when the precipitated particles are fully generated and grown in the reaction tube according to the present invention, there occurred no problem in the quality of the obtained hydrous zirconia sol in spite of a severe turbulences induced by the bubbles generated near the outlet of the reaction tube.

It is noted that T_{b} should be decided by considering the pressure in the reaction tube and the composition of the reactant. T_{b} may be raised as the pressure in the reaction tube is increased. Among the solvents constituting the aqueous solution of a zirconium salt, most high molecular-weight alcohols may have a boiling point of not less than 100° C. In this case, Tₒ may be in the range of 100° C. <Tₒ<T_{b}. It is, however, preferred to maintain Tₒ in the range of about 70˜100° C., because there is no problem in attaining the present invention even at Tₒ of not higher than about 100° C.

There can happen a heat loss in the course of heating performed in the tubular reactor(1). Then, corresponding to the heat loss, an excess amount of microwave(14) should be supplied. This leads to an increase in energy waste according to the electric energy for generating the excess amount of microwave. Therefore, it is preferable to install insulating materials(17) outside of the reaction tube(2) to reduce the heat loss when the heat loss is considerable.

It is required that the insulating materials(17) should not easily absorb but transmit the microwave like the reaction tube(2) so as not to deteriorate the microwave heating of the reactant due to the insulation. The insulating material(17) may be preferably provided in a blanket or molded block type. Otherwise, the space between the inner wall of the reactor(1) and the reaction tube(2) may be filled with spherical or granular type porous particles having a very low heat conductivity to reduce the heat loss.

The tubular reactor(1) used in the present invention may be installed in any direction for the aqueous solution(3a) of a zirconium salt to flow in a horizontal, vertical or diagonal direction.

It is also important to maintain as uniformly as possible the residence time of the reaction mixture in the reactor to prevent the increase of a size distribution and the deterioration of product quality that can be attributed to the distribution of the residence time. Accordingly, it is required that the reactor consisting of the reaction tube(s) should be also designed so that a partial stagnation or an excessive distribution of the residence time may not possibly occur throughout the flow of the reaction mixture.

There is no limitation in a cross-sectional shape of the reaction tube in which the reaction mixture flows. However, the cross-sectional shape of the reaction tube is preferably circular (inner diameter: D) or concentric annular (diameters of annular region: D₁ and D₂) to minimize the non-uniform flow, local stagnation, turbulence and to uniformly heat the reactant in the reaction tube(s).

FIG. 2b shows a structure of the tubular reactor wherein a cross section of the reaction tube is concentric annular. The aqueous solution of a zirconium salt (3a) in the reactor flows in the space of the annular region and is heated by microwave unlike the reaction tube having a circular cross section as illustrated in FIG. 2a.

The space of the inner tube(2′) of the concentric reaction tube(2) may be empty or filled with a heat insulating material. If necessary, the space of the inner tube(2′) may be supplied with a separate heating medium(7′) to alleviate the load of microwave heating and to more uniformly and effectively heat the reactant, i.e., the aqueous solution, as illustrated in FIG. 2b.

The separate heating medium(7′) applicable includes a liquid- or gas-phase medium, for example, heating oil, water, alcohol as well as the same solvent to be used in the aqueous solution of a zirconium salt.

It is required that the cross-sectional area of the reaction tube should not be excessively large in order to heat as uniformly as possible the reactant flowing in the reaction tube. When both the inner diameter of the reaction tube having a circular cross section and the equivalent diameter[=(D₂²−D₁²)^{1/2}] of the annular region of the concentric tubes are represented as ‘D’, the value of D is preferably about not more than 10 cm, more preferably, not more than about 3 cm. If the value of D is too low, it is difficult to control the flow of the reactant and to make the precipitated hydrous zirconia particles move freely entrained with the flow. Accordingly, the value of D is preferably at least about 0.01 cm.

The solvent used for the aqueous solution of a zirconium salt in the said reaction tube should satisfy the following formula when measured at 25° C. to satisfy at the same time both the flow characteristic and the uniform heating of the reactant according to the present invention:
ρ·u·D/μ≦2,000
wherein, ρ represents the density(g/cm³) of the solvent, μ the viscosity(g/cm·sec) of the solvent, the average flow velocity(cm/sec) of the solvent, and D the diameter or equivalent diameter of the cross section. Further, there is no problem even in a low value of not more than 1,000 in which the characteristic of the laminar flow dominated by shear stress is remarkably appeared.

It is predicted, from the viewpoint of the fluid dynamics, that the small size distribution of colloidal particles can hardly be controlled when the velocity gradient(8) is formed along the radial direction of the reaction tube owing to a shear stress applied in a laminar flow unlike the conventional static reaction system. It thus has been anticipated that the size distribution of the precipitated particles is necessarily large in accordance with the distribution of the residence time of the reactant due to the velocity gradient(8) in the reaction tube. On the contrary to this anticipation, it was surprisingly found that the particles of the hydrous zirconia sol(6) prepared continuously by using the microwave heated tubular reactor according to the present invention has a small size distribution and the agglomeration of the particles obtained thereby is unnoticeable.

In the meanwhile, it is not necessary to maintain the value of ρ·u·D/μ too low. When the average flow velocity(u) in a given tubular reactor is maintained very low, the heat duty to be supplied to the reactant is reduced. However, it is not necessary to reduce the value of u sacrificing the preparation rate, since the rate of heat transfer may be lowered in the reaction tube leading thereby to more difficulty in heating of the reactant. Therefore, the operational conditions of the reactor according to the present invention are preferably decided by considering the quality of the prepared hydrous zirconia sol, heating of the reactant, preparation rate, and the like.

The concentration of the aqueous solution of a zirconium salt used in the present invention, that is, the concentration of zirconium oxychloride widely used as a precursor of zirconia is not more than about 0.5 mole/l, preferably not more than about 0.2 mole/l. When the concentration of the zirconium salt is more than 0.5 mole per liter, the heating of the precursor aqueous solution in the reaction tube results in a gelation of particles upon the formation of hydrous zirconia particles in a high concentration. Accordingly, the quality of the hydrous zirconia excessively deteriorates and the flow of the reactant becomes difficult, thereby the continuous operation being impossible.

The low concentration of the aqueous solution of a zirconium salt does not cause any problems in performing the present invention. However, when the concentration is too low, the preparation rate of the desired hydrous zirconia is excessively lowered. Accordingly, the concentration of aqueous solution of a zirconium salt is preferably not less than about 0.001 mole/l.

In general, when the concentration of the aqueous solution of a zirconium salt is low, it is discovered that an average diameter of the prepared hydrous zirconia is reduced. However, this is not always the case. According to the present inventors' examination, the average diameter of the hydrous zirconia continuously prepared in the tubular reactor is smaller than that of the hydrous zirconia prepared by heating the aqueous solution of a zirconium salt in a static state, even though the concentrations are the same in both cases.

According to the present invention, since the average diameter, the size distribution and the particle's shape of the prepared hydrous zirconia are dependant on the concentration of aqueous solution of a zirconium salt, the composition of the solvent, the structure and the operational conditions of the reactor, the heating rate of the reactant, pH adjustment and the like, all the conditions relating to the precipitation are necessarily optimized.

As illustrated in the said hydrolysis formula, since the suspension(3b) in a state of sol primarily prepared in the tubular reactor according to the present invention contains many H⁺and Cl⁻ions and is a acidic solution having very low pH, it is required to be deionized. Further, the state of dispersion of the colloidal particles is also dependent on pH value of the solution. Therefore, it is often necessary to control the pH value of the suspension(3b) so that the pH value of a hydrous zirconia sol(6) may be in a range of about 5˜12 for the purpose of post-processing steps such as separation of byproducts(ions) out of the hydrous zirconia, and concentration and/or calcination and crystallization of hydrous zirconia; and of securing the quality of zirconia particles.

Various methods may be employed to control the pH value of the suspension(3b).

Firstly, it is possible to control the said pH value by continuously or intermittently adding an ammonia solution as a pH control agent to the suspension(3b) just before or after the suspension leaves the reaction tube(2). There may be used, as an ammonia aqueous solution, an ammonia(NH₃) dissolved in a distilled water, or an ammonia dissolved in a water-alcohol mixture used as a solvent for the aqueous solution of a zirconium salt.

Otherwise, the suspension(3b) leaving the reaction tube(2) may be mixed with a pH control agent(12) in a separate mixer(13), as illustrated in FIG. 2a. The mixer(13) may be a stirred-type vessel equipped with an agitation means or a vessel without with an agitation means wherein a suspension(3b) and a pH control agent(12) are mixed with each other in a just flowing state. Alternatively, as illustrated in FIG. 2b, they may be mixed before or after the outlet of the reaction tube of the tubular reactor or in the outlet tube of the suspension(3b) without with an agitation means. In addition to this method, it is also possible to control the pH value of a hydrous zirconia sol by continuously or intermittently adding a pH control agent(12) to the reservoir storing the suspension(3b) leaving the tubular reactor. The ammonia concentration of an ammonia aqueous solution is not specifically limited, but about 0.01˜10N of ammonia water is preferable.

Secondly, it is possible to control the said pH value of the suspension(3b) by contacting a gas containing an ammonia(NH₃) as a pH control agent with the suspension(3b). In this case, it is necessary to more sufficiently perform a gas-liquid contact between the suspension(3b) and the gaseous pH control agent(12). For the purpose of the contact, there may be employed various contact means as a gas-liquid mixer(13) as follows: (i) a scrubber contacting a gas with the reactant by spraying the reactant into numerous small droplets, (ii) a distillation column, (iii) a means allowing to introduce an ammonia-containing gas to the bottom of the reservoir of the reaction output (suspension) by distributing the ammonia-containing gas in the form of small bubbles, and the like. There may be used as an ammonia-containing gas a pure ammonia gas or an ammonia gas mixed with an inert gas such as air, nitrogen, argon and helium, which does not react with both ammonia and the reaction output at the room temperature.

Thirdly, it is possible to control the said pH value of the suspension(3b) by preliminarily mixing the aqueous solution of a zirconium salt(3a) with ammonium ion-producible materials such as urea(CO(NH₂)₂) and cerium diammonium nitrate ((NH₄)₂Ce(NO₃)₆), and then introducing the mixture to the reactor so as to automatically control the pH value of the aqueous solution in almost parallel with the precipitation in the reaction tube(2).

At least two methods among the said three methods are combined to control the pH value of a hydrous zirconia sol prepared according to the present invention.

As long as the reactor geometry and the operational conditions of the reactor are optimized in performing the present invention, there are no problems in terms of the agglomeration or particle size distribution of the hydrous zirconia particles obtained thereby. However, when it is practically difficult to optimize lots of operational conditions for a given reactor, the problems of the agglomeration or particle size distribution of the hydrous zirconia particles can also be reduced by additionally applying a dispersion agent thereto.

The dispersion agents to be used for this purpose are OH group- or COOH group-containing aqueous organic compounds. Among these, the organic compounds having higher boiling point than that of a solvent are preferable. The dispersion agents having relatively high molecular weight may be selected from at least one of hydroxy-propyl methyl cellulose, hydroxy propyl cellulose, sodium oleate, potassium ethylxanthate, poly(acrylic acid), polyvinyl alcohol, and polyoxyethylene nonionic surfactant. The dispersion agents having relatively low molecular weight may be selected from at least one of diol alcohols such as ethylene glycol, propylene glycol and 2-methyl-1,3-propanediol or multi-valent alcohols such as glycerol; and carboxylic acids containing OH group such as tartar acid, citric acid, malic acid and lactic acid.

The amount of the dispersion agent to be used is dependent on the concentration of the aqueous solution of a zirconium salt, the composition of the solvent, the kind of the dispersion agent selected and the like. But it may be used in a range of about 0.05 g˜20 g on the basis of one liter of the aqueous solution of a zirconium salt.

As mentioned above, only microwave as an energy source is not necessarily used for heating the reactant to continuously prepare the hydrous zirconia sol according to the present invention. As illustrated in FIG. 2b, a separate additional heating medium may also be used to alleviate the required amount of microwave supply.

In addition to this method, it may also be considered that the reactor(1) is partitioned into two or more reaction zones, and the reactant is heated finally to the required temperature (Tₒ) passing through the separate reaction zones the reactor shapes of which are different with each other. As illustrated in FIG. 1b and FIG. 1c, the reaction intermediate(5) may be heated to a certain temperature of T*(Tₚ<T*<Tₒ) by the first reaction zone(1a) heated with microwave, and then to the required temperature of Tₒ for preparation of a hydrous zirconia sol through the second reaction zone(1b) using a separate heating medium(7), if necessary.

In this case, the outlet temperature of T* in the first reaction zone(1a) for microwave heating of the reactant is basically required to be slightly higher than precipitation temperature(Tₚ) for the uniform generation of nuclei. The precipitation temperature (Tₚ) cannot be precisely measured in a practical manner, but the temperature at which the precipitation of particles starts to be visually observed during a lab-scale heating test of the aqueous solution of a zirconium salt can be conveniently used as Tₚ without a significant error.

The reactor as illustrated in FIG. 2a and FIG. 2b may be used as a first reaction zone(1a) for microwave heating, to which the second reaction zone(1b) having any kind of heat exchanger equipped with of straight- or coiled-type reaction tubes may easily be connected. A heat exchanger to be used in the second reaction zone(2b) may be a double pipe-type heat exchanger similar to FIG. 2a and FIG. 2b, or a shell-and-tube heat exchanger having multiple tubes.

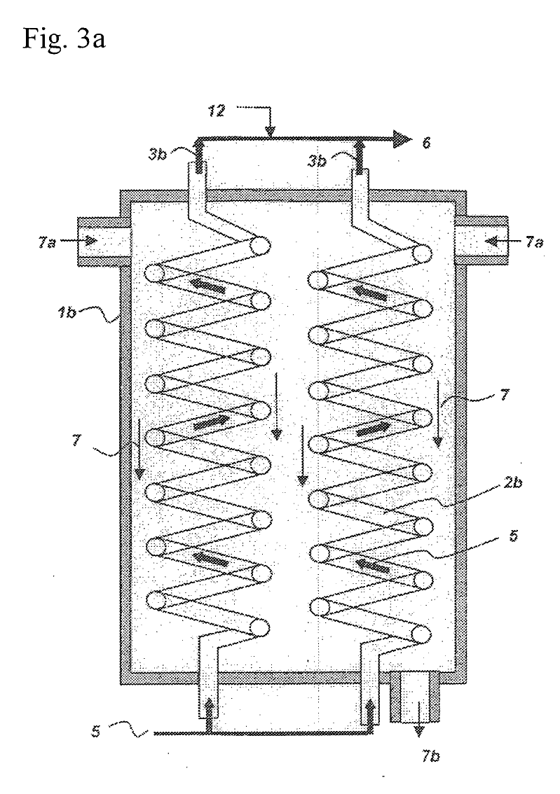

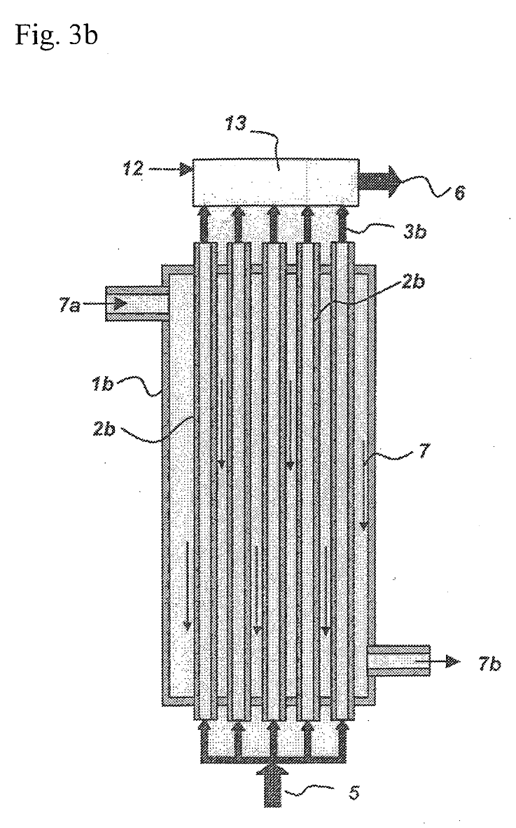

As an example, a heat exchanger consisting of coiled reaction tubes(2b) as illustrated in FIG. 3a may be connected to the first reaction zone(1a) for additionally heating the reaction intermediate (5). The gaseous or liquid heating medium(7) to be used in the second reaction zone(1b, FIG. 2) may be supplied via a single or multiple inlets(7a) and discharged through the outlet(7b) to attain more uniform heating and higher heat transfer effects.

As another example, a heat exchanger consisting of multiple straight reaction tubes(2b) as illustrated in FIG. 3b may be connected to the first reaction zone(1a, FIG. 2). After being distributed, the reaction intermediate(5) may be additionally heated to the required temperature through the reaction tubes(2b). The heating medium(7) may pass through the shell side of reaction tube(2b) in the second reaction zone(1b) as illustrated in FIG. 3b. Further, baffles may be additionally provided at the shell side to regulate the pathway of the heating medium and thus promote heat transfer efficiency.

Not being subjected to microwave heating, the reaction tube(2a) to be provided in the second reaction zone(1b) may be selected from metal materials such as carbon steel and stainless steel unlike the reaction tube(2a) of the first reaction zone(1a), or may be the same materials as for the reaction tube(2a) of the first reaction zone(1a).

The suspension(3b) discharged through the second reaction zone(1b) may be mixed with a pH control agent(12) in a discharging tube as illustrated in FIG. 3a, or may be collected in a separate mixing vessel(13) as illustrated in FIG. 3b and then mixed with a pH control agent(12) to continuously prepare a hydrous zirconia sol(6) as a final reaction product.

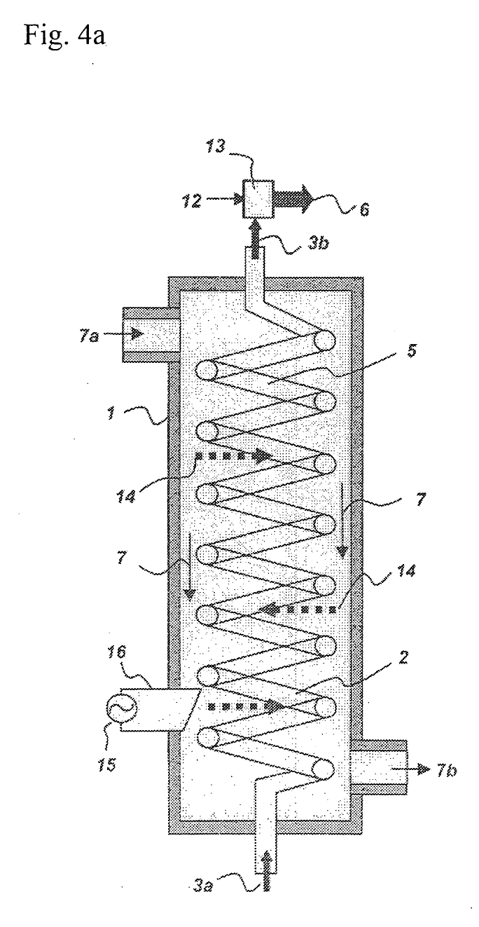

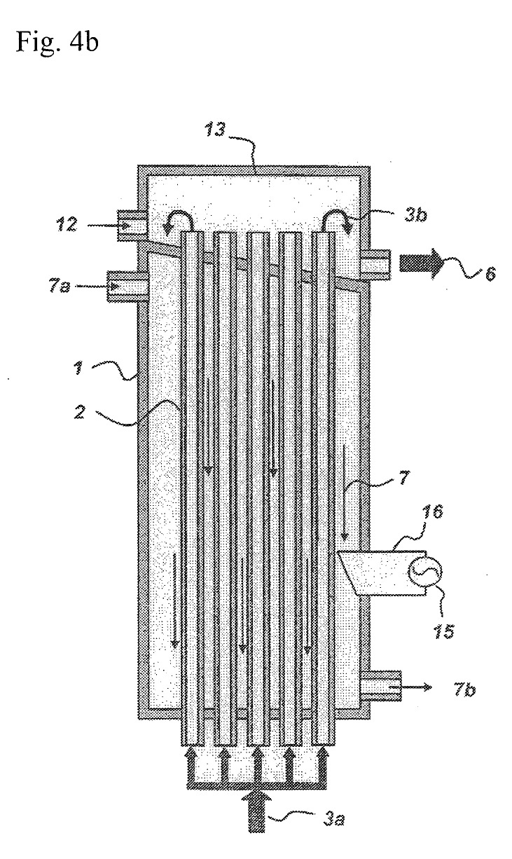

In addition to these methods, there may be used various methods in the present invention by combining other heating means together with microwave heating. FIG. 4a illustrates that the aqueous solution of a zirconium salt(3a) and the reaction intermediate(5) passing through the reaction tube are heated by using both microwave(14) and another heating medium(7) at the same time in a single tube reactor(1). Single reaction tube(2) is illustrated in FIG. 4a, but multiple reaction tubes may also be used as illustrated in FIG. 4b. Moreover, according to the present invention, a mixing vessel, i.e., mixer(13) may be combined to the reactor(1) so that the suspension(3b) prepared by heating to the required reaction temperature may be over-flown through the outlet of reaction tube(2) and then mixed with a pH control agent(12) as illustrated in FIG. 4b.

However, in case of such a hybrid heating system, undesirable absorption of microwave by the heating medium(7) should be prevented. It is thus necessary to use as a hydrocarbon heating medium(7) that does not substantially absorb but transmit the microwave introduced.

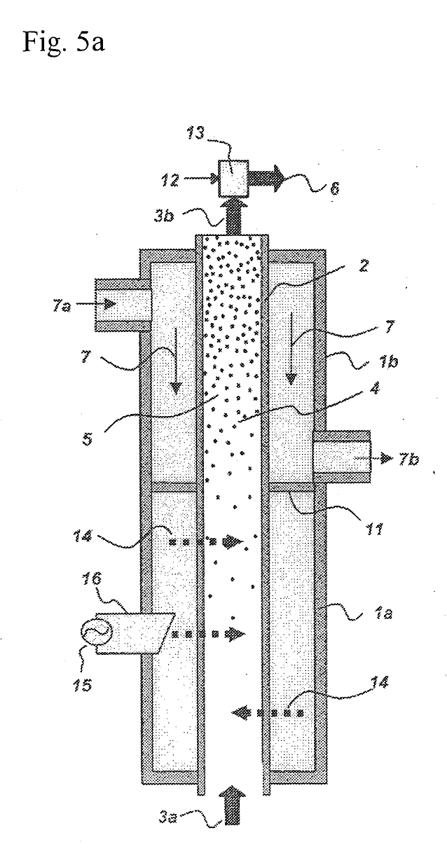

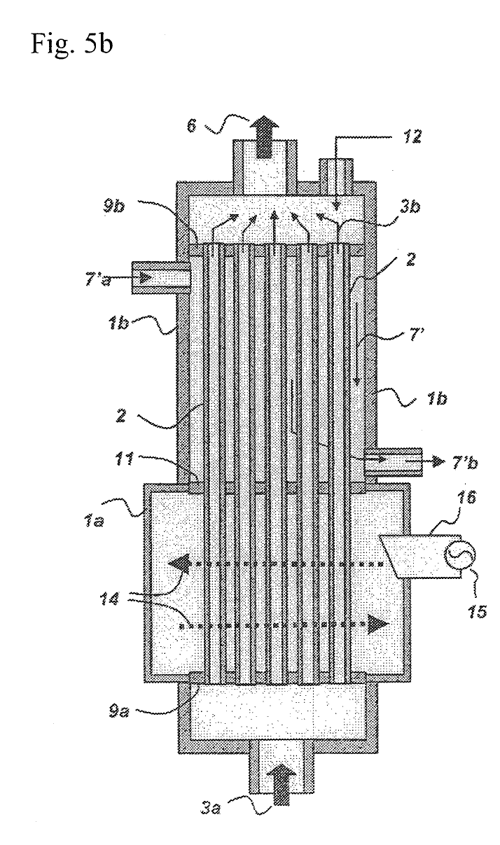

The effect of the said hybrid heating system can also be obtained in a reactor partitioned into many sections where microwave, heating medium and/or cooling medium are independently supplied. For example, FIG. 5a schematically shows a construction of the reactor wherein the tubular reactor(1) as illustrated in FIG. 2a is partitioned into a reaction zone(1a) heated with microwave and a reaction zone(1b) heated with another heating medium. According to this system, the aqueous solution of a zirconium salt (3a) is introduced to the reaction tube(2), primarily heated and precipitated with microwave(14) in the first reaction zone(1a), thereafter additionally heated with a separate heating medium(7) in the second reaction zone(1b), and then discharged in a state of suspension(3b) from the reaction tube(2).

As illustrated in FIG. 5b, this method can be applied to a shell-and-tube heat exchanger type reactor consisting of multiple reaction tubes. In this reactor, the reaction tube(2) fixed with tube-supporting plates(9a, 9b) is partitioned into a reaction zone(1a) heated with microwave, a reaction zone(1b) heated with another heating medium by installing a partition plate(11). In this case, the microwave introduced into the reaction zone(1a) is used in a primary heating of the aqueous solution of a zirconium salt (3a) introduced to the reaction tube(2).

Although not illustrated in the drawings, microwave can also be applied for heating at the reaction zone(1b) instead of another heating medium(7,7′) other than microwave. Then, microwave can be separately supplied by partitioning the first reaction zone(1a) and the second reaction zone(2b), allowing the amount of the microwave power to be adjusted along the flow direction of the reaction tube.

Based on such heating method of partitioning a reactor into several sections, the aqueous solution of a zirconium salt (3a) in the reaction tube(2) can pass through multiple heating zones. It is thus possible to control the power of microwave according to the flow distance(z). However, in this system, the balance should be optimized in the view of the product quality and the process feasibility, since the geometry and the operation of the reactor becomes complicated. Besides this example, although all examples not being illustrated herewith, various types of heat exchangers equipped with multiple heating tubes can be employed for practical application of the present invention.

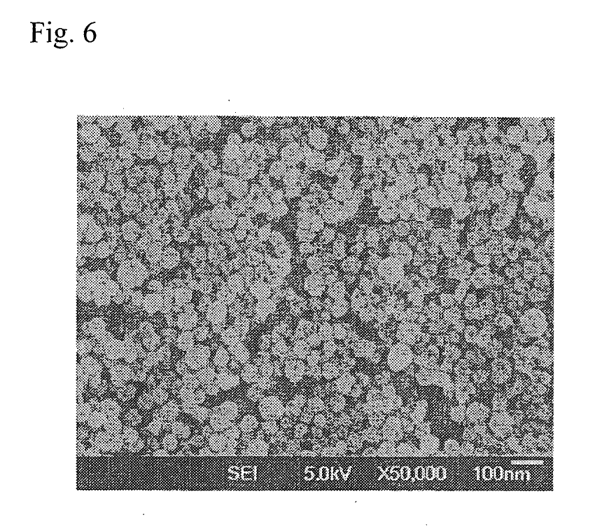

As stated in the above, the shapes of the hydrous zirconia particles constituting a hydrous zirconia sol continuously prepared by heating with microwave as an energy source according to the present invention are mostly spherical. The shapes can be confirmed by a high magnification scanning electron microscope(SEM) as illustrated in FIG. 6. The term “spherical” in this specification means a circle or an oval having a major-minor axial ratio of the cross section of the particles in a range of about 1.0˜1.5.

Further, the said hydrous zirconia particles exhibit very little agglomeration among them. According to the generally used image analysis method, the average diameter(dₚ) of the hydrous zirconia particles is in the range of about 1˜250 nm and the size distribution of the hydrous zirconia particles is as low as more than 90% of the particles has diameters in the range of 0.5 dₚ˜2dₚ.

Otherwise, most of these hydrous zirconia particles are amorphous. Departed from the present invention, these amorphous particles can be transformed to crystalline particles by subjecting them to the calcination at high temperatures, even though various the crystalline structures are possible depending on the calcination temperature.

The hydrous zirconia sol prepared is subjected to the post processing steps before it is used for the desired purpose. In general, the hydrous zirconia sol is subjected to washing and concentration steps through the separation method such as ultra filtration. In this washing process, the impurities contained in the hydrous zirconia sol can be removed by using water. This process may be performed before or after concentrating the sol.

The purified and concentrated hydrous zirconia sol can be used for various materials such as (i) electronic materials or coating materials in the form of stabilized sol itself, (ii) functional ceramics or electronic materials in the form of monodispersed, nanometer-sized powder subjected to drying and/or calcination, (iii) materials for catalysts or batteries/cells subjected to surface-modification by coating, (iv) functional ceramics or structural ceramics in the form of composite materials combined with other components, and the like.

Now, the preferred embodiments of the present invention will be described in detail by the following Examples without limiting the scope of the invention in any way.

### EXAMPLE 1

0.04 mole of zirconium oxychloride and 1g of hydroxy propyl cellulose are dissolved in one liter of the solvent mixture of 1-propyl alcohol and water (a molar ratio of 1.2) to prepare the aqueous solution of a zirconium salt. The aqueous solution of a zirconium salt is continuously supplied to a quarts glass tube having an inner diameter of 16 mm and equipped in a stainless steel reactor at the temperature of about 10° C. at a flowing rate of 403 cc/min. 2,450 MHz of microwave is irradiated to the solution to heat the solution so that the temperature at the outlet of the reaction tube may be 74° C. The pH value of the suspension discharged from the outlet of the reaction tube is controlled to 7.5 by adding 2N-ammonia water in a mixer to continuously prepare a hydrous zirconia sol.

The hydrous zirconia particles are filtered off the obtained hydrous zirconia sol through a 20 nanometer-sized filter and then repeatedly washed with distilled water until ions of Cl⁻ are not detected. The hydrous zirconia particles are dried at the temperature of 85° C. for 24 hours to observe the properties of the particles with SEM. The resultant hydrous zirconia particles are mostly spherical and do not exhibit agglomeration among them. It is confirmed that there are prepared the hydrous zirconia having size distribution as low as the diameter(d) of the particles is in the range of 50.3 nm ≦d≦122.8 nm, the average diameter(dₚ) is 91.2 nm, and the standard deviation is 14.8 nm.

The said hydrous zirconia particles are shown to be amorphous according to X-ray diffraction (XRD) analysis. But, they are crystallized in the course of calcination at the temperature of not less than 400° C., although their crystalline structure is different depending on the temperature.

Zirconia particles are obtained after removing bounded water from the hydrous zirconia by the said calcinations process. In this calcination, the average diameter is slightly reduced to 86.9 nm, but the size and the shape have been little changed and the agglomeration of the particles has not been newly found.

### EXAMPLE 2

0.06 mole of a zirconium oxychloride and 0.4 g of hydroxy propyl cellulose are dissolved in one liter of the solvent mixture of 2-propyl alcohol and water (a molar ratio of 0.8) to prepare the aqueous solution of a zirconium salt. The aqueous solution of a zirconium salt is continuously supplied to a quarts glass tube having an inner diameter of 16 mm and equipped in the first stainless steel reaction zone at the temperature of about 7° C. at a flowing rate of 910 cc/min. 2,450 MHz of microwave is irradiated to the solution to heat the solution so that the temperature at the outlet of the reaction tube may be 45° C.

The intermediate product discharged from the outlet of the reaction tube is continuously supplied to a reaction tube of the second reaction zone as a shell-tube heat exchanger type having 8 stainless reaction tubes of an inner diameter of 6 mm. A steam of about 106° C. as a heating medium is supplied to the shell side and condensed so that the temperature of the suspension discharged from the reaction tube of the second reactor zone may be 76° C.

The pH value is controlled to 8.2 by adding and mixing 0.4N-ammonia water in a discharging tube of the suspension mixer to continuously prepare a hydrous zirconia sol.

The hydrous zirconia particles are filtered off the obtained hydrous zirconia sol through a 20 nanometer-sized filter and then repeatedly washed with distilled water until ions of Cl⁻ are not detected. The hydrous zirconia particles are dried at the temperature of 85° C. for 24 hours to observe the properties of the particles with SEM. The resultant hydrous zirconia particles are mostly spherical and do not exhibit agglomeration among them. It is confirmed that there are prepared the hydrous zirconia having size distribution as low as the diameter(d) of the particles is in the range of 71.6 nm ≦d ≦205.1 nm, the average diameter(dₚ) is 139.5 nm, and the standard deviation is 21.3 nm.

### EXAMPLE 3

0.01 mole of zirconium oxychloride and 0.4 g of hydroxy propyl cellulose are dissolved in one liter of the solvent mixture of 2-propyl alcohol and water (a molar ratio of 1.6) to prepare the aqueous solution of a zirconium salt. The aqueous solution of a zirconium salt is continuously supplied to a quarts glass tube having an inner diameter of 12 mm and equipped in the first stainless steel reaction zone at the temperature of about 12° C. at a flowing rate of 362 cc/min. 2,450 MHz of microwave is irradiated to the solution to heat the solution so that the temperature at the outlet of the reaction tube may be 53° C.

The intermediate product discharged from the outlet of the reaction tube is supplied to the second stainless steal reaction zone having a stirred type vessel and an inner diameter of 120 mm and height of 600 mm. The height of the liquid in the second reaction zone is maintained at 400 mm, and the intermediate product is stirred with a stirrer installed in an axial direction of the reactor. The heating oil to be recycled through the heating jacket equipped on the wall of the reaction zone is heated to 160° C. The suspension discharged from the bottom of stirring vessel of the second reaction zone is heated to 78° C.

The pH value is controlled to 7.1 by adding and mixing 0.4N-ammonia water to a discharging suspension in a mixer to continuously prepare a hydrous zirconia sol.

The hydrous zirconia particles are filtered off the obtained hydrous zirconia sol through a 20 nanometer-sized filter and then repeatedly washed with distilled water until ions of Cl⁻¹ are not detected. The hydrous zirconia particles are dried at the temperature of 85° C. for 24 hours to observe the properties of the particles with SEM. The resultant hydrous zirconia particles are mostly spherical and do not exhibit agglomeration among them. It is confirmed that there are prepared the hydrous zirconia having size distribution as low as the diameter(d) of the particles is in the range of 21.4 nm ≦d≦68.8 nm, the average diameter(dₚ) is 43.2 nm, and the standard deviation is 6.1 nm.

### INDUSTRIAL APPLICABILITY

The hydrous zirconia particles prepared according to the present invention are unexpectedly excellent in quality. The hydrous zirconia particles constituting a hydrous zirconia sol are mostly spherical, have a small particle size distribution, that is, uniform diameter, and do not exhibit agglomeration among them. Particularly, these particles have an advantage that they do not exhibit agglomeration not only in a state of sol but also in the course of concentration and calcination.

The present invention provides a method for continuous preparation of a hydrous zirconia sol, which is feasible to be followed by separation and purification operations such as ultra filtration. Accordingly, the processes from the preparation of the hydrous zirconia sol to the separation and purification can also be continuously performed.

The tubular reactor to be used for continuous preparation of the hydrous zirconia sol according to the present invention has a conventional heat exchanger type, which is ordinarily used in normal chemical plants. Therefore, since the tubular reactor to be used in the present invention can be easily fabricated and can be assembled in various ways, there is no limit in applying the present invention to a commercial-scale bulk preparation.

Contrary to the method employing a conventional batch-type reactor or semi-continuous stirred-type reactor, the method for continuous preparation of a hydrous zirconia sol according to the present invention can allow various operational parameters to be controlled in a certain range and thus contributes to remarkably improve the quality of a hydrous zirconia sol to be prepared or of the zirconia powder obtainable as a final product.

1. A method for continuous preparation of a hydrous zirconia sol dispersed by nanometer-sized spherical hydrous zirconia particles having an average diameter(dₚ) of 1˜250 nm, which method comprises supplying the aqueous solution of a zirconium salt at a concentration of 0.001˜0.2 mole/l to a reactor consisting of one or more than two reaction tubes, and then irradiating microwave to the stream of the said aqueous solution in the reactor so that the said solution may be heated in a flow state.

2. A method for continuous preparation of a hydrous zirconia sol according to claim 1 wherein the said aqueous solution of a zirconium salt is heated to 70˜100° C.

3. A method for continuous preparation of a hydrous zirconia sol according to claim 1 wherein the said aqueous solution of a zirconium salt is heated to 70˜100° C. by supplying another heating medium in addition to the said microwave to the said reactor.

4. A method for continuous preparation of a hydrous zirconia sol according to claim 1 wherein a solvent constituting the said aqueous solution of a zirconium salt is a mixture of water and at least one alcohol selected from a group consisting of ethyl alcohol, 1-propyl alcohol, 2-propyl alcohol and butyl alcohol; a mole ratio of the said alcohol/water mixture is 0.5˜5.0; and a zirconium salt is selected from zirconium oxychloride, zirconium tetrachloride, zirconyl nitrate or zirconium sulfate.

5. A method for continuous preparation of a hydrous zirconia sol according to claim 1 wherein the pH value of a hydrous zirconia sol is 5˜12.

6. A method for continuous preparation of a hydrous zirconia sol according to claim 1 wherein the average diameter(dₚ) of the hydrous zirconia particles is about 10˜150 nm.

7. A method for continuous preparation of a hydrous zirconia sol according to claim 1 wherein the cross sectional shape of the reaction tube is circular or concentric annular form, and the value of D is 0.01˜3 cm when a diameter of the said circle or an equivalent diameter corresponding to a concentric annular region is “D.”

8. A method for continuous preparation of a hydrous zirconia sol according to claim 1 wherein a dispersant is added to the said aqueous solution of a zirconium salt at the concentration of 0.05˜20 g/.l.

9. A method for continuous preparation of a hydrous zirconia sol according to claim 1 wherein the said reactor is partitioned into multiple heating zones.

10. A method for continuous preparation of a hydrous zirconia sol according to claim 8 wherein the said dispersant is at least one selected from a group consisting of hydroxy-propyl methyl cellulose, hydroxy propyl cellulose, sodium oleate, potassium ethylxanthate, poly(acrylic acid), polyvinyl alcohol, polyoxyethylene nonionic surfactant, ethylene glycol, propylene glycol, 2-methyl-1,3-propanediol, glycerol, tartar acid, citric acid, malic acid and lactic acid.

11. A method for continuous preparation of a hydrous zirconia sol according to claim 7 wherein the solvent of the aqueous solution of a zirconium salt in the said reaction tube satisfies the following formula when measuring at the temperature of 25° C.:
ρ·u·D/μ≦2,000
wherein, ρ represents the density(g/cm³) of the solvent, μ the viscosity(g/cm·sec) of the solvent, u the average flow velocity(cm/sec) of the solvent, and D the diameter or the equivalent diameter of the cross section.
